(19) United States
(12) Patent Application Publication
(10) Pub. No.: US 2022/0029837 A1
(43) Pub. Date: Jan. 27, 2022

(54) ELECTRONIC DEVICE AND METHOD FOR AUTHENTICATION OF AN ELECTRONIC DEVICE

(71) Applicant: RESADO GMBH, Lippetal (DE)

(72) Inventors: Florian ERNST, Lippetal (DE); Armin BABAEI, Frankfurt am Main (DE)

(73) Assignee: RESADO GMBH, Lippetal (DE)

(21) Appl. No.: 17/297,317

(22) PCT Filed: Nov. 28, 2019
(86) PCT No.: PCT/EP2019/082983

§ 371 Date: May 26, 2021

Related U.S. Application Data
(60) Provisional application No. 62/772,843, filed on Nov. 29, 2018.

(51) Int. Cl. H04L 9/32; H04L 9/08; G06F 21/76

(52) U.S. Cl. CPC H04L 9/3278; H04L 9/3273; H04L 2209/12; G06F 21/76; H04L 9/0866

(57) ABSTRACT

The present document described an electronic device (120) which comprises a hardware platform (122) and a physical unclonable function, referred to as PUF, circuit (123), which is placeable in K different regions (301) on the hardware platform (122), leading to K different spatial PUF configurations of the PUF circuit (123). The electronic device (120) is configured to determine a challenge (111); to determine a currently valid PUF configuration out of the K different PUF configurations; and to determine a local response (121) to the challenge (111) using the PUF circuit (123) according to the valid PUF configuration.

### TECHNICAL FIELD

The present document relates to methods and systems for enabling an efficient and reliable authentication of an electronic device, notably an Internet of Things (IOT) device.

### BACKGROUND

It is expected that the Internet of Things (IOT) will enable various different services and applications. In the context of IOT, physical objects or devices are enhanced with embedded electronics to become identifiable, to sense their environment, and/or to connect to a global communication network. The individually identifiable devices may be integrated to provide new applications, e.g., in the context of the so called fourth industrial revolution (Industry 4.0).

In order to be able to provide efficient and reliable applications, an IOT device should exhibit relatively low energy consumption, should be cost efficient (which typically leads to limited computational resources) and should be secured against cyberattacks. These constraints or objectives are at least partially incompatible. In particular, energy footprint concerns and the scarcity of computational resources typically limit the cryptographic methods which may be implemented for an IOT device, making it difficult to implement traditional security mechanisms.

The present document addresses the technical problem of providing a resource efficient and reliable scheme for authentication of an IOT device, notably of an FPGA (Field Programmable Gate Array) based device.

### SUMMARY

According to an aspect, an electronic device (notably an IOT device) is described. The electronic device comprises a hardware platform. Furthermore, the electronic device comprises a physical unclonable function (PUF) circuit, which is placeable in K different regions on the hardware platform, leading to K different spatial PUF configurations of the PUF circuit. The electronic device is configured to determine a challenge and to determine a currently valid PUF configuration out of the K different PUF configurations. Furthermore, the electronic device is configured to determine a local response to the challenge using the PUF circuit according to the valid PUF configuration.

According to another aspect, a remote device (e.g. a server) which is configured to communicate with an electronic device (e.g. an IOT device) is described. The remote device is configured to store K different sets of challenge-response pairs (CRPs) for a PUF circuit of the electronic device, which exhibits K different spatial PUF configurations. Each set of CPRs typically comprises a certain number Q (e.g. Q=10 or more, Q=100 or more, or Q=1000 or more) of CPRs. As a result of this a total of K×Q CPRs may be provided on the remote device. Furthermore, the remote device is configured to determine a challenge, and to determine a currently valid PUF configuration out of the K different PUF configurations. In addition, the remote device is configured to determine a remote response to the challenge using the stored set of CRPs for the valid PUF configuration.

According to another aspect, a method for enabling and/or performing a security related process (notably an authentication process, a fingerprinting process and/or an encryption/decryption process) involving an electronic device (e.g. an IOT device) is described. The electronic device comprises a hardware platform and a physical unclonable function (PUF) circuit, which is placeable in K different regions on the hardware platform, leading to K different spatial PUF configurations. The method comprises determining a challenge, and determining a currently valid PUF configuration out of the K different PUF configurations. In addition, the method comprises determining a local response to the challenge using the PUF circuit according to the valid PUF configuration.

According to a further aspect, a method for enabling and/or performing a security related process (notably an authentication process, a fingerprinting process and/or an encryption/decryption process) involving a remote device is described. The method comprises providing, at the remote device, K different sets of challenge-response pairs (CRPs) for a PUF circuit of an electronic device, which exhibits K different spatial PUF configurations. As indicated above, each set of CRPs may comprise Q CRPs, such that K×Q different CRPs may be provided by the K different sets of CRPs. Furthermore, the method comprises determining a challenge, and determining a currently valid PUF configuration out of the K different PUF configurations. In addition, the method comprises determining a remote response to the challenge using the stored set of CRPs for the valid PUF configuration.

According to a further aspect, a software program is described. The software program may be adapted for execution on a processor and for performing the method steps outlined in the present document when carried out on the processor.

According to another aspect, a storage medium is described. The storage medium may comprise a software program adapted for execution on a processor and for performing the method steps outlined in the present document when carried out on the processor.

According to a further aspect, a computer program product is described. The computer program may comprise executable instructions for performing the method steps outlined in the present document when executed on a computer.

It should be noted that the methods and systems including its preferred embodiments as outlined in the present document may be used stand-alone or in combination with the other methods and systems disclosed in this document. In addition, the features outlined in the context of a system are also applicable to a corresponding method. Furthermore, all aspects of the methods and systems outlined in the present document may be arbitrarily combined. In particular, the features of the claims may be combined with one another in an arbitrary manner.

In the present document, the term “couple” or “coupled” refers to elements being in electrical communication with each other, whether directly connected e.g., via wires, or in some other manner.

### SHORT DESCRIPTION OF THE FIGURES

The invention is explained below in an exemplary manner with reference to the accompanying drawings, wherein

FIG. 1a illustrates an example system for mutual authentication of a device and a server;

FIG. 1b shows an example physical unclonable function (PUF);

FIG. 1c shows an example ring oscillator (RO) for a PUF;

FIGS. 2a and 2b show differently placed PUFs on an FPGA;

FIG. 3 shows different PUF architectures in different clock regions of an FPGA;

FIG. 4a illustrates how different PUF architectures on an FPGA lead to different responses to a common challenge;

FIGS. 4b and 4c shows different PUF architectures in different locations of an FPGA;

FIG. 4d shows a memory unit for challenge-response-pairs (CRPs) of a server with different sets of CRPs for different spatial PUF architectures;

FIG. 5a shows a flow chart of an example method for enabling an authentication process on an electronic device;

FIG. 5b shows a flow chart of an example method for enabling an authentication process on a remote device;

FIG. 6a shows a flow chart of an example method for performing an authentication process at a local device (e.g. at an IOT device or at a server); and

FIG. 6b shows a flow chart of an example method for performing an authentication process at a remote device (e.g. at a server or at an IOT device).

### DETAILED DESCRIPTION

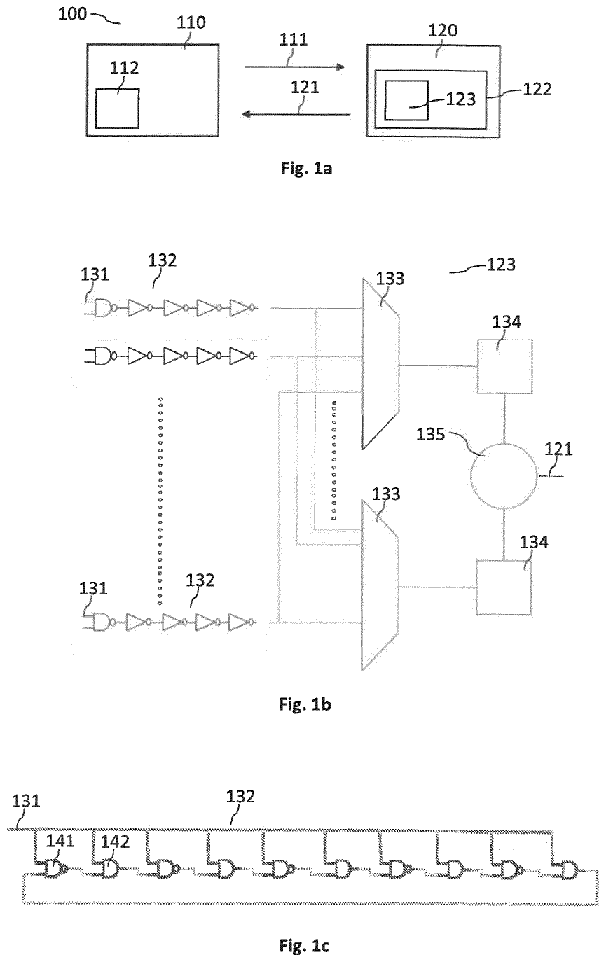

FIG. 1 a shows an example system 100 comprising a local device 120 (e.g. an IOT device) and a remote device 110 (e.g. a server), which may need to authenticate each other. The remote device 110 (referred to as the server in the following) may send a challenge 111 to the local device 120 (referred to the “device” in the following), and the device 120 may generate a response 121 based on the challenge 111 and may send the response 121 to the server 110. The server 110 may compare the response 121 which is provided by the device 120 with an expected response that is stored within a challenge-response-pair (CRP) memory unit 112. If the received response 121 is identical with the stored response, the device 120 may be authenticated at the server 110.

The device may comprise a so called physical unclonable function (PUF) architecture or circuit 123 (or PUF 123, in short), which is configured to generate a response 121 for a challenge 111. The PUF architecture 123 may be implemented within a subregion of a FPGA 122 (Field Programmable Gate Array).

A PUF circuit or architecture 123 makes use of the uniqueness of the physical microstructures of an electronic component, notably of an FPGA 122, wherein the microstructures are caused by random effects during manufacturing of the electronic component. The random effects are typically uncontrollable, such that it can be considered to be impossible to produce two electronic components which exhibit the same physical microstructures. A PUF circuit or architecture 123 exploits the differences of the physical microstructure of different electronic components, such that a PUF circuit 123, which is implemented on a first electronic component, generates a different response to a challenge than a PUF circuit 123, which is implemented on a different second electronic component.

Physical Unclonable Functions (PUFs) 123 may be used as a light-weight, ubiquitous and low-cost solution for secure IOT devices 120. PUFs 123 may act as a fingerprint for IOT devices 120, allowing reliable identification of IOT devices 120. At the same time, an IOT device 120 may comprise one or more

PFGAs 122, in order to allow the IOT device 120 to be flexibly adapted, in terms of software and/or hardware, e.g. to adapt the IOT device 120 to unforeseen application scenarios and/or security concerns.

FPGAs 122 comprise one or more Configurable Logic Cells (CLBs) that can instantiate specialized hardware architectures at runtime. An FPGA 122 thus allows changing of the hardware of a device 120 dynamically. FPGAs 122 are typically used for chip prototyping and/or for System on Chip (SOC) design. A flexible IOT device 120 may be implemented by placing one or more hardware modules of the device 120 on an FPGA 122, e.g. one or more hardware modules ranging from a micro-controller to a special module for signal processing or encryption.

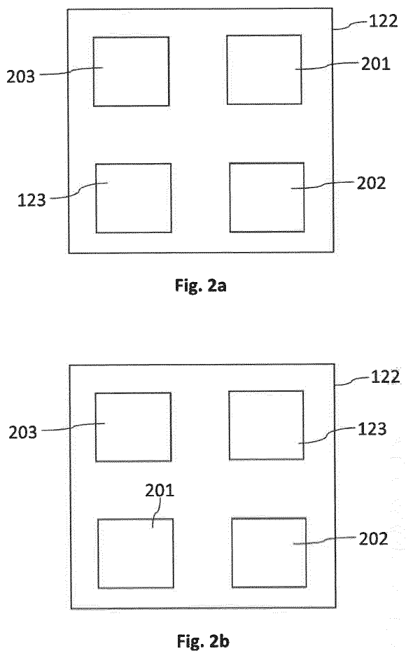

FIG. 2a shows an example FPGA 122 with a PUF circuit or PUF architecture 123. The depicted IOT device 120 comprises four different modules 201, 202, 203, 123 that are placed on the FPGA, i.e. three functional modules 201, 202, 203 and the PUF circuit 123. Since the energy consumption of the resulting IOT device 120 depends on the size of the FPGA 122, it is typically preferable to use an FPGA 122 with a relatively small number of CLBs. By way of example, a XC7A35T FPGA (from the Artix family) having 5200 CLBs may be used. As the FPGA 122 hosts multiple functional modules 201, 202, 203, a PUF circuit 123 uses only a fraction of the available CLBs, e.g., 10-20% of the available CLBs. As a result of using only a limited number of CLBs, the resulting PUF circuit 123 supports only a relatively small number of secure identifications, which may not be sufficient for the lifetime of the IOT device 120.

In the present document, an approach for increasing the number of identifications that a PUF circuit 123, which is implemented on an FPGA 122, can handle securely is described. This approach does not increase the size of the PUF circuit 123, thereby making the approach applicable for low energy and/or small scale IOT devices 120 with relatively long lifetimes.

As illustrated in FIG. 2b, the PUF circuit 123 on an FPGA 122 may change its position or location on the PFGA 122, thereby changing the responses 121 which are generated by the PUF circuit 123. In particular, the PUF circuit 123 may swop its position with a functional module 201, thereby providing a different PUF 123 on the same FPGA 122. In other words, by varying the placement of the PUF 123 on an FPGA 122, additional fingerprinting data sets can be created, wherein the fingerprinting data sets (notably the challenge-response pairs) are unique and independent from each other.

As indicated above, PUF circuits 123 may be intrinsically created during a manufacturing process or an electronic component. A PUF circuit 123 receives as input a sequence of bits, called a challenge 111, and generates a sequence of bits, called a response 121, as the output. The PUF circuits 123 may be designed such that PUF circuits 123 implemented on different electronic components generate different responses 121 for the same challenge 111. The combination of a challenge and its corresponding response is called a challenge-response pair (CRP). PUF circuits 123 may be categorized into weak and strong PUFs. Weak PUFs have a relatively small number of CRPs, and strong PUFs have a relatively large number of CRPs. Using a PUF typically does not guarantee full system security. There are a number of known ways to attack PUFs as well as different proposed solutions to overcome the possible attaches. The approach described herein can integrate these solutions and, by doing so, can be made secure against known PUF attacks.

A PUF circuit 123 may be used for authentication. The authentication may work as follows: First the server 110 sends a sequence of challenge bits (i.e. a challenge 111) to the IOT device 120. The JOT device 120 may then generate a sequence of response bits (i.e. a response 121) using the PUF circuit 123, and may send the response 121 back to the server 121. If the response bits match the expected response bits (which are pre-stored within a CRP storage unit 112 on the server 110), then the IOT device 120 is authenticated. Otherwise, the authentication process may be aborted.

For each authentication, at least one CRP may need to be used. Since JOT devices 120 are often expected to be used for multiple years, the TOT devices 120 may need to authenticate themselves for a relatively high number of times, using a relatively high number of CRPs. Using 15% of the above mentioned FPGA 122 for the PUF circuit 123 may allow the generation of 8128 CRPs.

To provide an increased number of CRPs, different approaches may be used. A possible approach is to reuse CRPs. This allows operating a device 120 with a relatively low number of CRPs, but it requires the CRPs to remain secret. For this purpose, cryptographic methods may be used to protect the CRPs. This, however, leads to an increased resource utilization for the IOT device 120, which leads to increased hardware requirements and increased energy consumption. In addition, this approach introduces new risks, e.g. replay attacks or the risk of breaking the encryption. A further approach is to provide a sufficiently high number of CRPs for a relatively high number of authentications using a relatively large PUF circuit 123, which is configured to generate an increased number of CRPs. This, however, requires the use of relatively large FPGAs 122 having an increased power consumption.

The above mentioned approaches lead to increased computational resources and to increased energy consumption. This is contrary to the original reason for using a PUF 123, which is to provide a lightweight authentication solution that introduces little overhead. In contrast to the above mentioned approaches, the approach which is described in the present document increases the number of supported CRPs on a PUF circuit 123 without increasing the size of the PUF circuit 123. The approach may be referred to as spatial reconfigurable PUF.

The goal is to increase the number of CRPs which are supported by a PUF without increasing the size of the PUF circuit 123. This goal may be achieved by defining multiple regions on an FPGA 122 and by placing a separate (but architecturally identical) PUF circuit 123 in each of the regions. This may be done by online re-programming of the FPGA 122 and/or by using the dynamic partial reconfiguration (DPR) technology of FPGAs. As a result of this, the number of CRPs which may be provided by the FPGA 122 may be increased (without increasing the size of the PUF circuit 123). Each PUF circuit 123 (i.e. each instantiation of the PUF circuit 123) may be stored in a memory of the PFGA 122 or may be sent remotely and programmed offline or via DPR. During operation, only one PUF circuit 123 (i.e. one instantiation of the PUF circuit 123) may be used for any given authentication operation. However, the particular PUF circuit and/or region, which is used for authentication, may be changed regularly, e.g., just before or just after an authentication is performed. The differently placed PUF circuits 123 may be referred to as different PUF architectures 123 or different PUF configurations 123.

In the following, details are provided on the type of PUF which may be used, on the size of a PUF which may be used, and/or on the placement of the different PUF circuits 123 (i.e. the different PUF configurations or PUF architectures) on an FPGA 122.

Possible PUF types are SRAM (Static random-access memory) PUFs or RO (Ring Oscillator) PUFs. RO PUFs are relatively flexible (notably in terms of implementation on a FPGA 122) and are relatively reliable. In addition, RO PUFs have relatively good statistical properties. Hence, RO PUFs may be used within the approach that is described in the present document. An example RO PUF circuit 123 is shown in FIG. 1b.

The RO PUF circuit 123 of FIG. 1b comprises N identical Ring Oscillators (ROs) 132, which respectively oscillate with different frequencies (f1, f2, . . . , fN). The different frequencies may be due to regionally different microstructures of the FPGA 122 (as outlined above). The ROs 132 may be enabled using an enable signal 131. Each incoming challenge 111 selects a pair of different ROs 132 (via a respective pair of multiplexers 133) from the N ring oscillators 132. The two counters 134 each receive an output of a respective multiplexer 133, and asynchronously count the number of logic 1's that each RO 132 generates (by the respective multiplexer 133). After a given period of time, the value of both counters 134 is measured. Depending on which value is higher (i.e., the output of the first counter 134 or the second counter 134), a logic 0 or 1 will be generated by the comparator 135 as the output response 121. Although the N ROs 132 are architecturally identical, due to process variations, no two ROs 132 from the N ROs 132 are truly identical (thereby leading to different frequencies). The comparison between the count values of the two counters 134 (which is based on the respective speeds or frequencies of the two selected ROs 132) determines the value of the response bit. In a similar manner, multiple response bits may be generated for an output response 121,

The number of different CRPs, which may be generated in an RO PUF circuit 123 with N ROs 132, may be given by N(N−1)/2. By increasing the number N of ROs 132, the number of CRPs increases. Taking into account the size of an FPGA 122 which is typically used in an embedded system (e.g., an XC7a35T FPGA) 128 or 256 RO pairs may be provided (e.g. when using 10% or 18% of the available resources, respectively, for the RO PUF circuit 123). The remaining resources of the FPGA 122 may be used for other purposes or other functional modules 201, 202, 203, e.g., as a general purpose computation core or as a digital signal processing core.

A RO PUF circuit 123 may be sensitive to different environmental conditions that can cause spurious inputs, which may limit the PUF circuit's 123 suitable use-case scenarios. To address this concern, reliable RO PUF operation may be achieved by using an adapted RO architecture that compensates for environmental sensitivity, such as shown in FIG. 1c. FIG. 1c shows a modified ring oscillator 132, which includes a two input AND gate 142 added between each step (NAND gate 141) of the RO, with one common pin 131 for all of the gates. When the common pin 131 is a logic 1, the ring oscillator 132 is operating, otherwise the RO 132 is off By putting a “hard” logic 1 on the common pin 131, protection against a spurious voltage on the data input being incorrectly interpreted as the wrong logic level may be provided. Hence, this configuration stabilizes the overall RO PUF architecture 123 by helping to reduce or eliminate bursts and glitches. An alternative solution is to use flip-flops instead of AND gates 142, which leads to the same result.

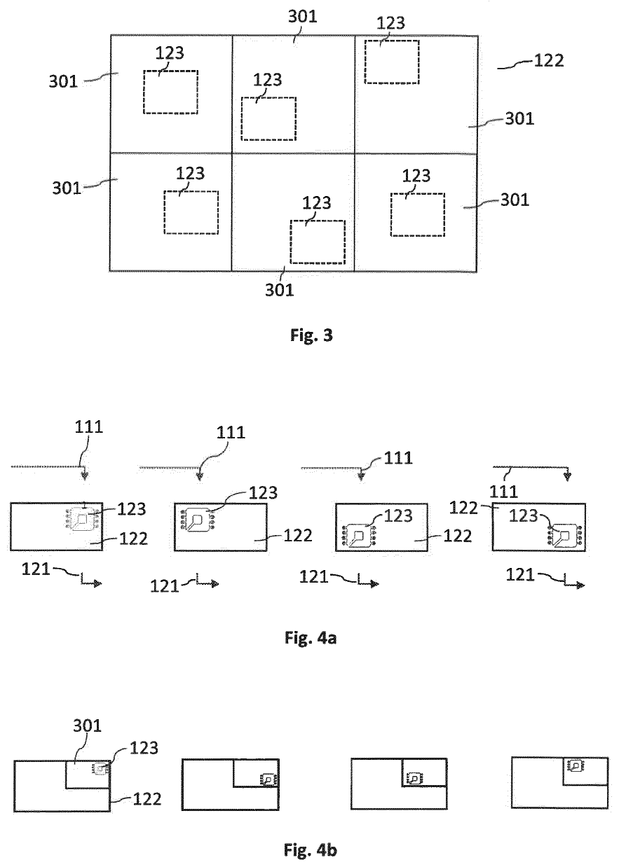

The number of CRPs may be increased by implementing the PUF circuit 123 in different regions 301, notably in different clock regions, of the FPGA 122, as illustrated in FIG. 3. The regional clock within a clock region 301 of an FPGA 122 typically has a direct influence on the oscillation frequencies of the different ROs 132. As a result of this, the PUF circuit 123 behaves differently in the different clock regions 301. FIG. 3 shows an example of an FPGA 122 with six different clock regions 301, wherein each clock region 301 may be used to host the PUF circuit 123. The border lines of the clock regions 301 are shown as solid lines. An identical RO PUF circuit 123 may be implemented at like or different locations within each of these clock regions 301 (FIG. 3 shows partially like and partially different locations as an example; in general, the locations and/or orientations of the PUF circuits 123 may be varied). The RO PUF architecture 123 is typically the same in all the clock regions 301, but due to one or more constraints (e.g., input/output (I/O) ports, response uniformity, etc.) their physical footprints may be compacted horizontally and/or vertically. Hence, each clock region typically acts like a unique PUF that is distinguishable from the other ones.

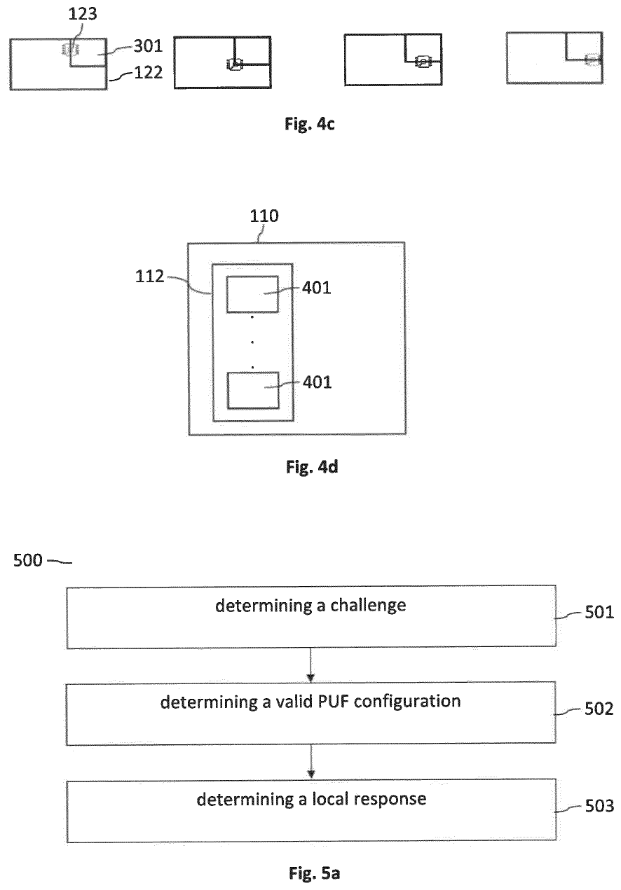

In an example, the technique described herein repeatedly rotates and/or changes the placement of a PUF circuit 123 between different clock regions 301 of the FPGA 122, thereby enabling the generation of different unique CRPs. As illustrated in FIG. 4a, the same PUF circuit 123 placed in different regions 301 on the FPGA 122 leads to different responses 121 for the same challenge 111, thereby providing different CRPs. The rotation of the location of the PUF circuit 123 may be performed manually while the device 120 is offline (e.g. by a user of the device 120 or remotely by a remote service), or the rotation/modification of the location may be performed dynamically during operation of the device 120 (e.g., using Dynamic Partial Reconfiguration (DRP) technology). The generated CRPs have no correlation, and each “clock region-set” of CRPs acts like an independent FPGA or like an independent PUF. This means that by placing the PUF circuit 123 on different “clock regions” 301 of a FPGA 122, which may be done on an infinite number of different places within a “clock region” 301, wherein the number of “clock regions” 301 may vary depending on a FPGA chip's size and performance, the technology is able to use a single FPGA 122 as if there were multiple different FPGAs in one chip, each of the multiple FPGAs allowing the generation of unique CRPs.

FIG. 4a shows an example of a PUF circuit 123 placed in four different “clock regions” 301. In all four scenarios the FPGA 122 is identical or the same. By rotating the placement of the PUF circuit 123, the generated CRPs are unique and/or identical, as can be proven by computing inter-hamming and intra-hamming distance. Each PUF circuit 123 is located in a dedicated clock region 301. Alternatively, or additionally, the system is able to generate unique and identical CRPs by rotating the PUF circuit placement between an infinite number of different positions within any one of the clock regions 301, as shown in FIG.

4b. In particular, FIG. 4b shows an example of a PUF circuit 123 placed in four different positions within a single clock region 301. Alternatively, or additionally, the PUF circuit 123 may be rotated between an infinitive number of different places between (i.e., overlapping) different “clock regions” 301, wherein the CRPs are unique, uniform and independent. FIG. 4c shows an example of a PUF circuit 123 placed at four different positions between, i.e. at the borders of, different clock regions 301.

The techniques described herein may be used to achieve one or more of the following advantages:
Using the characteristic as a way of building up a hierarchical identity and access management system (each party is able to use its own group of CRPs that may be dedicated to one clock region 301).
Instead of using a large PUF circuit 123 to generate a relatively large number of CRPs, the technology enables the use of a relatively small PUF circuit 123, wherein additional CRPs can be generated by rotating and/or by modifying the placement of the PUF circuit 123 on the FPGA 122.
By using DPR technology, the system is able to rotate and/or modify the placement of the PUF circuit 123 during the operation mode of the FPGA 122. Furthermore, the placement of the PUF circuit 123 may be changed manually, when the FPGA 122 and/or the device 120 is offline. These features may be used to make a communication protocol between a server 110 and a device 120 resilient against machine learning attacks.

Using the techniques which are described in the present document, the number of unique CRPs that are supported by, for example, a 128 RO PUF may be increased e.g. from 8128 to 48768, which is six times higher than the original PUF. To do so, a PUF circuit 123 may be placed within each of the (six different) FPGA clock regions 301, and the system 100 may switch between the different PUF circuits 123 during runtime. Each clock region 301 may act as an identifiable PUF circuit 123 that is distinguishable from the other PUF circuits 123 in the other clock regions 301. Yet the approach described herein does not increase the required space on the used FPGA 122 and occupies only a relatively small percentage (e.g. 20% or less) of the available resources on a typical FPGA 122. This allows an efficient integration of the approach into an SOC (system on chip) design.

Relatively large PUF circuits 123 may not exhibit the above mentioned flexibility (due to the required resources). If more space is available on an FPGA 122, then larger sized PUF circuits 123 may be used to generate an increased number of CRPs. It should be noted, however, that the response bit uniqueness in large size PUF circuit 123 may be a problem.

Switching between FPGA configurations 123 is preferably performed relatively infrequently, such that energy consumption for configuration switching may be neglected. FPGA configuration switching may e.g. be performed, (only) once the CRPs of the current configuration are used up. DRP technology may be used to reduce the switching overhead and possible downtime.

Additional placement strategies may be used. By placing PUF circuits 123 in overlapping clock regions 301, for example, it may be possible to gain more placements and to further increase the number of achievable CRPs. The above-described approach for different spatial PUF circuits 123 may be combined with reconfigurable PUFs, thereby further increasing the number of CRPs.

In the following a protocol is described, which allows a server 110 and a device 120 to enable the use of spatial reconfigurable PUFs 123 and/or to make use of spatial reconfigurable PUFs 123. The protocol comprises an enrolment phase during which the server 110 learns the responses 121 which are generated by the devices 120 for the available set of challenges 111. By doing this, the server 110 may generate the challenge-response-pairs (CRPs) which are generated by the device 120 using a PUF circuit or architecture 123. This process may be repeated for the different spatial placements of the PUF circuit or architecture 123 within the FGPA 122 of the device 120, thereby providing a plurality of sets of CRPs for the corresponding plurality of spatial configurations of the PUF circuits 123. The plurality of sets 401 of CRPs may be stored within a memory unit 112 of the server 110 (as illustrated in FIG. 4d).

During an authentication phase, the server 110 and/or the device 120 may use the stored sets 401 of CRPs and/or the differently configured PUF circuits 123 to perform one or more authentication processes. For this purpose, it needs to be ensured that the server 110 and the device 120 refer to the same PUF configuration 123. It may be assumed that a total of K different spatial PUF configurations 123 are available, identifiable using the index k=1, . . . , K. During initialization of the system 100, one of the PUF configurations 123 (e.g. the configuration 1) may be selected. The server 110 and the device 120 may then use the configuration 1 to authenticate the device 120 and/or the server 110. For authentication of the device 120, the server 110 may send a challenge Cᵢ to the device 120 and the device 120 may generate the response Rᵢ₁(Cᵢ) using the PUF configuration 1. Furthermore, the device 120 may send the response Rᵢ₁ to the server 110. The server 110 may read out the response Rᵢ₂(Cᵢ) from the stored set 401 of CRPs for the PUF configuration 1. If the responses Rᵢ₂ and Rᵢ₁ are equal, the device 120 is authenticated, otherwise authentication is unsuccessful.

In a similar manner, the device 120 may authenticate the server by receiving the challenge Cᵢ and the response Rᵢ₂(Cᵢ) from the server 110, by generating the response Rᵢ₁(Cᵢ) for the challenge Cᵢ and by comparing the generated response Rᵢ₁(Cᵢ) with the received response Rᵢ₂(Cᵢ).

For changing the PUF configuration 123, the server 110 and the device 120 may make use of an identical random number generator, which is configured to provide an integer number between 1 and K as an output, in order to identify one of the PUF configurations 123. The server 110 (or the device 120) may select an auxiliary challenge Cₛ for the PUF configuration 123 which is currently active (e.g. the PUF configuration 1). The auxiliary challenge Cₛ may be passed to the device 120 (or the server 110), and both, the server 110 and the device 120, may determine the auxiliary response Rₛ(Cₛ) for the auxiliary challenge Cₛ. The auxiliary response Rₛ(Cₛ) may then be used as an input to the random number generator, in order to allow the server 110 and the device 120 to determine the index of the next PUF configuration 123. In view of the fact, that the server 110 and the device 120 use identical random number generators, the indexes, which are determined at the server 110 and the device 120, should be identical. By doing this, the server 110 and the device 120 are enabled to agree on a joint PUF configuration 123 in a secure manner (because the PUF circuits 123 are only known to the server 110 and the device 120).

Hence, the present document describes a system 100 comprising an electronic device 120 (also referred to herein as the local device, or the device, in short) and a remote device 110 (also referred to herein as a server). In particular, the present document describes an electronic device 120 and/or a remote device 110, which may be involved in an authentication process. The electronic device 120 may be an IOT device.

The electronic device 120 may comprise a hardware platform 122 (e.g. a microchip). In a preferred example, the hardware platform 122 comprises or is a Field Programmable Gate Array (FPGA).

Furthermore, the electronic device 120 comprises a physical unclonable function (PUF) circuit 123, which is placeable in K different regions 301 on the hardware platform 122, leading to K different spatial PUF configurations of the PUF circuit 123. In other words, by placing the PUF circuit 123 in K different regions or locations of the hardware platform 122 K different (spatial) PUF configuration may be provided. K may be an integer, with K>1. In particular, K may be 5 or greater, 6 or greater, 10 or greater.

The K different regions of the hardware platform 122 and/or the PUF circuit 123 may be such that the PUF circuit 123 exhibits K different sets 401 of challenge-response pairs (CRPs) for the K different PUF configurations. Alternatively, or in addition, the PUF circuit 123 may be such that a set 401 of CRPs (for a single PUF configuration) comprises Q=100 or more, or Q=1000 or more, or Q=10000 or more CRPs. The different CRPs may be used for different authentication processes, and/or each of the different CRPs may be used for a particular authentication process (between the electronic device 120 and the remote device 110). Hence, the electronic device 120 may be configured to provide K×Q different CRPs.

The electronic device 120 may be configured to determine a challenge 111. The challenge 111 may be used for enabling the remote device 110 to authenticate the electronic device 120. In this case, the challenge 111 may be received at the electronic device 120 from the remote device 110. Alternatively, or in addition, the challenge 111 may be used by the electronic device 120 to authenticate the remote device 110. In this case, the challenge 111 may be selected by the electronic device 120 (and may be sent to the remote device 110). Alternatively, or in addition, the challenge 111 may be used for selecting a joint valid PUF configuration (which may be used in a coordinated manner at the electronic device 120 and at the remote device 110).

Furthermore, the electronic device 120 may be configured to determine the currently valid PUF configuration out of the K different PUF configurations (wherein the currently valid PUF configuration may be used in a coordinated manner at the electronic device 120 and at the remote device 110). The jointly used valid PUF configuration may be selected upon initialization of the electronic device 120 and/or of the remote device 110. Alternatively, or in addition, the jointly used valid PUF configuration may be selected using the selection protocol, which is described in the present document (e.g. by using an auxiliary challenge 111, as outlined above and/or below).

The electronic device 120 may further be configured to determine a local response 121 to the challenge 111 using the PUF circuit 123 according to the currently valid PUF configuration. In particular, the local response 121 may be calculated or generated using the PUF circuit 123 on the hardware platform 122 of the electronic device 120. The local response 121 may be used for authentication of the electronic device 120 and/or of the remote device 110. Alternatively, or in addition, the local response 121 may be used for selecting a new valid PUF configuration (in a coordinated manner at the electronic device 120 and at the remote device 110).

By making use of a PUF circuit 123 in different spatial PUF configurations on a (single) hardware platform 122, the number of CRPs which may be made available on an electronic device 120 may be increased in an efficient manner (without the need of increasing the size of the PUF circuit 123 and/or of the hardware platform 122). By doing this, the number of authentication processes which may be performed by the electronic device 120 may be increased in an efficient manner.

The FPGA (of the hardware platform 122) may comprise one or more different clock regions with different clocks. At least some of the K different regions 301 for the K different PUF configurations of the PUF circuit 123 may lie within different clock regions of the FPGA. Alternatively, or in addition, at least some of the K different regions 301 for the K different PUF configurations may lie within different subregions of one clock region of the FPGA. Alternatively, or in addition, at least one of the K different regions 301 for the K different PUF configurations may lie on a border between two different clock regions of the FPGA and/or at least one of the K different regions 301 for the K different PUF configurations may lie within and/or may spread across two different clock regions. Hence, different placements of the PUF configurations may be used, thereby allowing the use of a relatively high number K of different PUF configurations. The FPGA may e.g. comprise L different clock regions, with L being an integer, with L>1 (e.g., L≥5, 6, 10). The number K of PUF configurations may be equal to or greater than L, using e.g. the above mentioned placement strategies.

The PUF circuit 123 may occupy only a fraction of the hardware platform 122 for each of the K different PUF configurations. The remaining space of the hardware platform 122 may be used for implementing one of more functional modules 201, 202, 203 of the electronic device 120, for providing one or more functions of the electronic device 120.

The electronic device 120 may be configured to alter the position of at least one functional module 201, 202, 203 on the hardware platform 122, when changing the PUF configuration of the PUF circuit 123. In particular, the electronic device 120 may be configured to swap the position of a functional module 201 with the position of the PUF circuit 123, when changing the PUF configuration of the PUF circuit 123. By doing this, the available space of the hardware platform 122 of the electronic device 120 may be used in a particularly efficient manner.

The K different PUF configurations may form a sequence of PUF configurations, wherein the different PUF configuration may be indexable using index numbers 1 to K. The electronic device 120 may be configured to change the currently valid PUF configuration sequentially according to the sequence of PUF configurations and/or according to the index numbers 1 to K. Furthermore, when reaching the PUF configuration K, the PUF configuration 1 may be used as the subsequent valid PUF configuration. Hence, the electronic device 120 may be configured to cycle through the sequence of PUF configurations, when selecting the currently valid PUF configuration. By doing this, the joint PUF configuration for the electronic device 120 and for the remote device 110 may be agreed upon in a particularly efficient manner.

In a preferred example, the PUF circuit 123 comprises a ring oscillator PUF for generating the remote response 121 to a challenge 111. Alternatively, or in addition, the PUF circuit 123 may comprise a plurality of ring oscillators 132 for generating the remote response 121 to a challenge 111. The ring oscillators 132 of the PUF circuit 123 may comprise a sequence of NAND gates 141 with interjacent AND gates and/or flip flop circuits 142. By making use of such a PUF circuit 123, the remote responses 121 may be determined in a reliable and robust manner.

The electronic device 120 may comprise a storage unit which is configured to store configuration data for at least one or for all of the K different PUF configurations. Alternatively, or in addition, the electronic device 120 may be configured to receive configuration data regarding at least one or all of the K different PUF configurations (e.g. from a service location). The configuration data may be indicative of at least one of the K different regions on the hardware platform 122 for implementing a corresponding one of the K different PUF configurations. In other words, the configuration data may be indicative of how to implement the PUF circuit 123 according to a particular PUF configuration.

The electronic device 120 may be configured to selective implement the PUF circuit 123 according to a selected one of the K different PUF configurations using the configuration data. By doing this, the reconfiguration of the PUF circuit 123 may be performed in an efficient and reliable manner.

The electronic device 120 may be configured to alter the PUF configuration online during operation of the electronic device 120, notably using dynamic partial reconfiguration. Alternatively, or in addition, the electronic device 120 may be configured to alter the PUF configuration offline and/or from a remote service location. As a result of this, the PUF configuration may be adapted in a flexible and efficient manner.

As indicated above, the PUF circuit 123 may be used to enable an authentication of the electronic device 120 at the remote device 110. For this purpose, the electronic device 120 may be configured to receive the challenge 111 from the remote device 110. Furthermore, the electronic device 120 may be configured to send the local response 121 to the remote device 110, in order to enable the remote device 110 to authenticate the electronic device 120.

Alternatively, or in addition, the PUF circuit 123 may be used to enable the electronic device 120 to authenticate the remote device 110. For this purpose, the electronic device 120 may be configured to receive a remote response for the challenge 111 from a remote device 110. The remote response may be derived at the remote device 110 using a stored set 401 of CRPs for the currently valid PUF configuration. Furthermore, the electronic device 120 may be configured to compare the remote response to the local response 121 and to authenticate the remote device 110 in dependence of the comparison. In particular, authentication may be achieved if the remote response and the local response 121 are found to be equal. Otherwise authentication may be considered to have failed.

Alternatively, or in addition, the electronic device 120 may be configured to identify a new valid PUF configuration based on the local response 121. In an analogous manner, the new valid PUF configuration may be determined based on the remote response at the remote device 110. In this case, the challenge 111 may be considered to be an auxiliary challenge (as outlined above). By doing this, the PUF configurations may be changed in a reliable and secure manner.

In particular, the electronic device 120 may be configured to identify the new valid PUF configuration using a random number generator (wherein the same random number generator may be used by the remote device 110). The random number generator may be or may comprise a non-deterministic and/or true random number generator or a deterministic or pseudo-random number generator. The random number generator may be configured to provide an integer index number between 1 and K in dependence of the local response 121. The index number, which is provided by the random number generator, may be indicative of the PUF configuration out of the K different PUF configurations, which is to be used as the new valid PUF configuration.

The electronic device 120 may be configured to perform an enrolment phase, in order to provide the corresponding remote device 110 with the CRPs of the PUF circuit 123 (according to the K different configurations). For this purpose, the electronic device 120 may be configured to receive a set of different challenges 111 from the remote device 110, and to generate a corresponding set of different local responses 121 for the set of different challenges 111 using the PUF circuit 123 according to the valid PUF configuration. The determined set of different local responses 121 may then be provided to the remote device 110. In particular, the electronic device 120 may be configured to generate K different sets of different local responses 121 for the set of different challenges 111 using the PUF circuit 123 according to the K different PUF configurations, respectively. The K different sets of different local responses 121 may then be provided to the remote device 110. As a result of this, reliable authentication processes between the electronic device 120 and the remote device 110 are enabled.

The electronic device 120 may be configured to adapt the type of the PUF circuit 123 which is placed in the K different regions 301 on the hardware platform 122. Alternatively, or in addition, a setting of an operational parameter (e.g. the supply voltage) which is used for operating the PUF circuit 123 may be adapted. The adaption may be performed such that for each type of PUF circuit 123 and/or for each setting of the operational parameter, the PUF circuit 123 provides a different set 401 of challenge-response pairs (CRPs). By modifying the type of PUF circuit 123 and/or by modifying a setting of an operation parameter, the number of CRPs which are available at an electronic device 120 may be increased further.

The electronic device 120 may be configured to change the valid PUF configuration subsequent to processing a pre-determined number (e.g. one or more, two or more, or five or more) of challenges 111. Alternatively, or in addition, the electronic device 120 may be configured to change the valid PUF configuration once a pre-determined number (e.g. one or more, two or more, or five or more, or all) of challenge-response pairs from the currently valid PUF configuration have been used. By making use of a pre-determined strategy for changing the valid PUF configuration, the efficiency of an authentication process may be increased further.

Furthermore, a remote device 110 is described in the present document, which performs tasks that are complimentary to the electronic device 120. In particular, a remote device 110 is described, which is configured to communicate with the above mentioned electronic device 120 (using complimentary functional steps to the ones used by the electronic device 120).

The remote device 110 may be configured to store K different sets 401 of challenge-response pairs (CRPs) for a PUF circuit 123 of the electronic device 120, which exhibits K different spatial PUF configurations. Furthermore, the remote device 110 may be configured to determine a challenge 111, to determine a currently valid PUF configuration out of the K different PUF configurations, and to determine a remote response to the challenge 111 using the stored set 401 of CRPs for the valid PUF configuration.

The challenge 111 and/or the remote response may be used for an authentication process and/or for determining a new valid PUF configuration.

In particular, the remote device 110 may be configured to send the challenge 111 to the electronic device 120, and to receive a local response 121 to the challenge 111 from the electronic device 120 (which has been generate at the electronic device 120 using the PUF circuit 123 according to the currently valid PUF configuration). Furthermore, the remote device 110 may be configured to compare the local response 121 to the remote response, and to authenticate the electronic device 120 based on the comparison. The electronic device 120 may be authenticated if the remote response and the local response 121 are found to be equal. Otherwise, the authentication may be considered to have failed.

Alternatively, or in addition, the remote device 110 may be configured to receive the challenge 111 from the electronic device 120, and to send the remote response to the electronic device 120, in order to enable the electronic device 120 to authenticate the remote device 110.

Alternatively, or in addition, the remote device 110 may be configured to identify a new valid PUF configuration based on the remote response. In particular, the remote device 110 may be configured to identify the new valid PUF configuration using a (true- or pseudo-) random number generator (which may be identical to the one used by the electronic device 120). The random number generator may be configured to provide an integer index number between 1 and K in dependence of the remote response, wherein the index number may be indicative of the PUF configuration out of the K PUF configurations, which is to be used as the new valid PUF configuration.

The sets 401 of CRPs for the different PUF configurations may be determined using an enrolment phase. For this purpose, the remote device 110 may be configured to send a set of different challenges 111 to the electronic device 120. Furthermore, the remote device 110 may be configured to receive a corresponding set of different local responses 121 for the set of different challenges 111, which have been generated using the PUF circuit 123 according to the valid PUF configuration. The set of different local responses 121 in conjunction with the set of different challenges 111 may be stored as the set 401 of CRPs for the valid PUF configuration.

Furthermore, the remote device 110 may be configured to receive K different sets of different local responses 121 for the set of different challenges 111, which have been generated using the PUF circuit 123 according to the K different PUF configurations, respectively. The K different sets of different local responses 121 in conjunction with the set of different challenges 111 may be stored to provide the K different sets 401 of CRPs for the K different PUF configurations, respectively.

It should be noted that a CRP may be used by the electronic device 120 and/or by the remote device 110 to enable a secure communication using encryption. In particular, a local response 121 to a challenge 111 may be used by the electronic device 120 to encrypt a message (e.g. using symmetric encryption), and the corresponding remote response to the challenge 111 may be used by the remote device 110 to decrypt the message (or vice versa).

Hence, the electronic device 120 may be configured to receive a challenge 111 from the remote device 110. Alternatively, the challenge 111 may be selected by the electronic device 120 (and may be sent to the remote device 110. Furthermore, the electronic device 120 may be configured to encrypt a message using the local response 121 to the challenge 111, thereby generating an encrypted message. The encrypted message may then be sent to the remote device 110.

In a complimentary manner, the remote device 110 may be configured to send a challenge 111 to the electronic device 120, or to receive a challenge 111 from the electronic device 120. Furthermore, the remote device 110 may be configured to receive, from the electronic device 120, an encrypted message which has been encrypted using the local response 121 to the challenge 111. The encrypted message may then be decoded at the remote device 110 using the remote response.

It should be noted that the communication process may be performed the other way around. In particular, the remote device 110 may be configured to encrypt a message using the remote response to a challenge 111, and the electronic device 120 may be configured to decrypt the encrypted message using the local response to the challenge 111. The challenge 111 may be selected by the remote device 110 and may be sent to the electronic device 120. Alternatively, the challenge 111 may be selected by the electronic device 120 and may be sent to the remote device 110.

The above mentioned communication may also be performed in the opposite direction, with the electronic device 120 sending a challenge to the remote device 110, and the remote device 110 using the remote response to the challenge to encrypt a message, and the electronic device 120 using the local response to the challenge to de it the message. Hence, a secure communication between the remote device 110 and the electronic device 120 may be enabled.

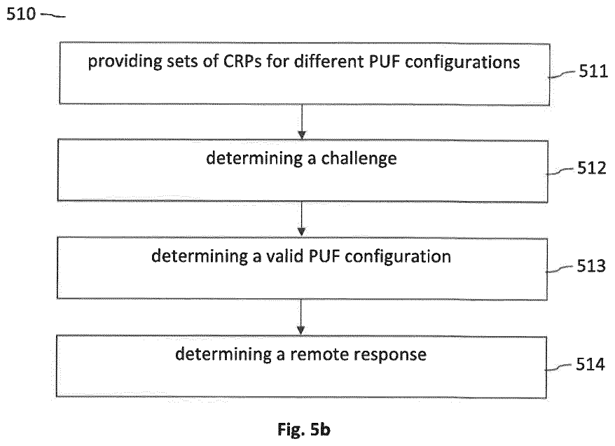

FIG. 5a shows a flow chart of an example method 500 for enabling and/or performing a security related process (notably an authentication and/or fingerprinting and/or an encryption process) involving an electronic device 120. As outlined above, the electronic device 120 may comprise a hardware platform 122. Furthermore, the electronic device 120 may comprise a physical unclonable function (PUF) circuit 123, which is placeable in K different regions 301 on the hardware platform 122, leading to K different spatial PUF configurations, wherein K is an integer, with K>1.

The method 500 comprises determining 501 a challenge 111, and determining 502 a currently valid PUF configuration out of the K different PUF configurations. Furthermore, the method 500 comprises determining 503 a local response 121 to the challenge 111 using the PUF circuit 123 according to the valid PUF configuration. It should be noted that the method 500 may be combined with any one or more of the features described in the present document.

FIG. 5b shows a flow chart of an example method 510 for enabling and/or performing a security related process (notably an authentication and/or fingerprinting and/or an encryption process) involving a remote device 110. The method 510 comprises providing 511, at the remote device 110, K different sets 401 of challenge-response pairs (CRPs) for a PUF circuit 123 of an electronic device 120, which exhibits K different spatial PUF configurations. Furthermore, the method 510 comprises determining 512 a challenge 111, and determining 513 a currently valid PUF configuration out of the K different PUF configurations. In addition, the method 510 comprises determining 514 a remote response to the challenge 111 using the stored set 401 of CRPs for the valid PUF configuration. It should be noted that the method 510 may be combined with any one or more of the features described in the present document.

In the present document K different PUF configurations are provided using K different regions 301 on a hardware platform 122. It should be noted that alternatively, or in addition, the K different PUF configuration may be provided by performing other kinds of modifications to the PUF circuit 123, e.g. by using different kinds of types of PUF circuits 123 and/or by using different settings of an operational parameter of the PUF circuit 123. In general, the aspects which are described in the present document are applicable to a PUF circuit 123 which may be implemented according to K different PUF configurations (possibly without using K different regions 301 of the hardware platform 122).

Hence, an electronic device 120 is described which comprises a hardware platform 122 and a PUF circuit 123 which exhibits K different PUF configurations, with K being an integer, with K>1. The electronic device 120 may be configured to determine a challenge 111, to determine a currently valid PUF configuration out of the K different PUF configurations, and to determine a local response 121 to the challenge 111 using the PUF circuit 123 according to the valid PUF configuration. The features which have been described are also applicable to this electronic device 120.

In a complimentary manner, a remote device 110 is described. The remote device 110 may be configured to communicate with an electronic device 120. The remote device 110 may be configured to store K different sets 401 of CRPs for a PUF circuit 123 of the electronic device 120, which exhibits K different PUF configurations. The remote device 110 may be configured to determine a challenge 111, to determine a currently valid PUF configuration out of the K different PUF configurations, and to determine a remote response to the challenge 111 using the stored set 401 of CRPs for the valid PUF configuration.

The remote device 110 may be configured to encrypt a message using the remote response to a challenge 111, thereby generating an encrypted message, and to send the encrypted message to the electronic device 120. The electronic device 120 may be configured to receive, from the remote device 110, the encrypted message which has been encrypted using the remote response to the challenge. Furthermore, the electronic device 120 may be configured to decrypt the encrypted message using the local response to the challenge 111. Hence, secure communication may be enabled.

As indicated above, the electronic device 120 (in the following referred to as the local device 110) and the remote device 110 may make use of the CRPs for performing a mutual authentication process. In the following, methods 600, 620 are described for a process or a protocol, which
enables the local device 120 to authenticate the remote device 110;
enables the local device 120 and the remote device 110 to change the PUF configuration (also referred to as the PUF architecture); and
enables the remote device 110 to authenticate the local device 120 using the new PUF architecture.

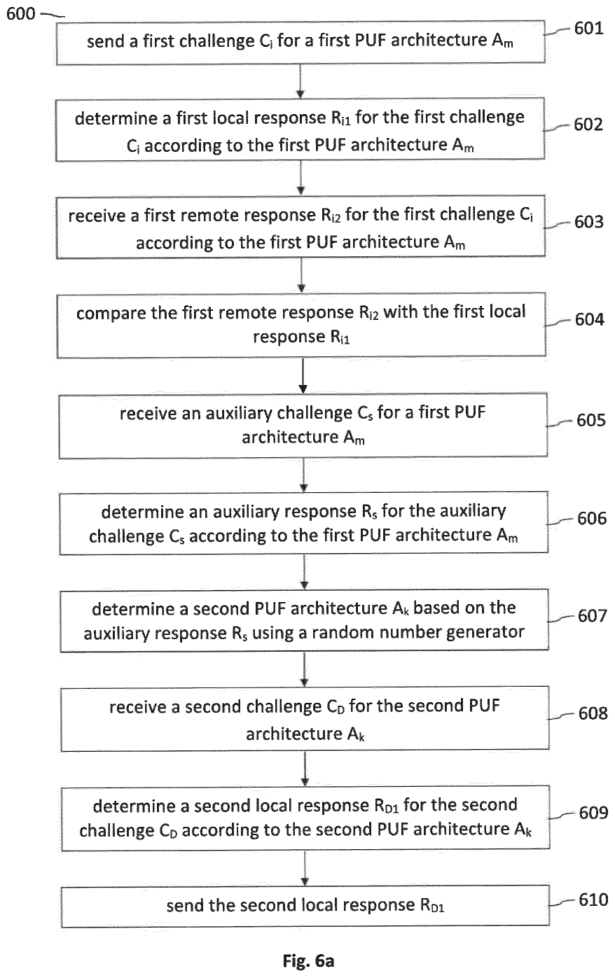

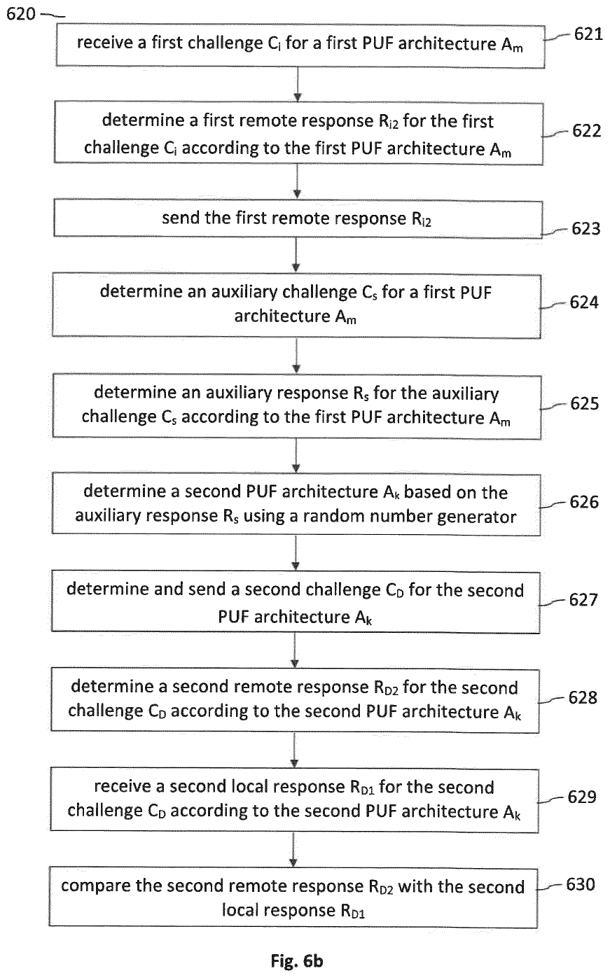

FIG. 6a shows a flow chart of an example method 600 which is performed by the local device 120, and FIG. 6b shows a flow chart of a corresponding method 620 which is performed by the remote device 110.

The local device 120 sends 601 a first challenge for the first PUF architecture to the remote device 110, which receives 621 the first challenge. The local device 120 may determine 602 a first local response for the first challenge (e.g. using the PUF circuit 123 according to the first PUF architecture). In a complementary manner, the remote device 110 may determine 622 a first remote response for the first challenge (e.g. using the set 401 of CRPs for the first PUF architecture). The first remote response may be sent to the local device 120 (step 623) and the local device 120 may receive the first remote response (step 603). Furthermore, the local device 120 may compare the first remote response with the first local response, in order to authenticate the remote device 110 (step 604).

In a following phase, the PUF architecture may be changed. For this purpose, the remote device 110 may determine a first auxiliary challenge (step 624) and may send the first auxiliary challenge to the local device 120, which may receive the auxiliary challenge (step 605). Using the first PUF architecture, an auxiliary response for the auxiliary challenge may be determined at the local device 120 (step 606) and at the remote device 110 (step 625). Furthermore, the second PUF architecture may be determined using a random number generator and using the auxiliary response at the local device 120 (step 607) and at the remote device 110 (step 626).

The second PUF architecture may then be used by the remote device 110 to authenticate the local device 120. For this purpose, the remote device 110 may determine and send a second challenge to the local device 120 (step 627), which may be received by the local device 120 (step 608). Both devices 110, 120 may then determine a second response using the second PUF architecture (steps 609 and 628). The local device 120 may send the second local response to the remote device 110 (step 610), and the remote device 110 may receive the second local response (step 629). Furthermore, the remote device 110 may compare the second local response to the second remote response (step 630) to authenticate the local device 120.

It should be noted that alternatively, or in addition, the local device 120 may make use of the second local response for encrypting a message. In other words, the second local response may be used as a key for encrypting a message. The local device 120 may be configured to apply one or more different encryption techniques (notably symmetric encryption). The encrypted message may be sent to the remote device 110. The remote device may make use of the second remote response for decrypting the encrypted message. Hence, a CRP may be used for encryption purposes, in order to enable a secure communication between the local device 120 and the remote device 110. The secure communication process may be performed in an analogous manner by the remote device 110 for sending an encrypted message to the local device 120. In this case, the remote device 110 may make use of the (second) remote response for encrypting the message, and the local device 120 may make use of the (second) local response for decrypting the message.

After the authentication process is completed, the remote device 110 (notably the server) knows the current architecture Aₖ (e.g. the second PUF architecture), which is loaded into the electronic device 120. The remote device 110 may encrypt a package of data message M with the response Rₚ (e.g. the second remote response), which is the response of challenge Cₚ (e.g. the second challenge) for architecture Aₖ. The encrypted message M (and the challenge Cₚ) may be sent to the electronic device 120. The electronic device 110 may then generate the response Rₚ (e.g. the second local response) and may use the response for the decryption of the message M.

Hence, the remote device 110 and/or the local (electronic) device 120 may be configured to use the response to a challenge for encrypting a message. The remote device 110 and the local device 120 are considered to be in sync with regards to the currently used PUF architecture. The challenge may be selected by the device 110, 120 which is encrypting the message. In this case, the challenge may be sent to the decrypting device 120, 110 along with the encrypted message, in order to enable the decrypting device 120, 110 to determine the response and to use the response to decrypt the message. Alternatively, the challenge may be selected by the device 110, 120 which is decrypting the message. In this case, the decrypting device 110, 120 sends the challenge to the encrypting device, which determines the response and which uses the response for encrypting the message. The encrypted message is then sent to the decrypting device, which decrypts the message using the response to the challenge that has been determined at the decrypting device.

Note that while the present description focuses on the authentication of resource constrained IOT devices 120, the techniques introduced herein may also be used for secure communication between IOT devices 120 and/or for other types of devices. Additionally, the techniques introduced herein are not limited to IOT devices 120, and may be applied to all applications and use-case scenarios that face similar circumstances and/or challenges.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1. An electronic device comprising:
a hardware platform; and
a physical unclonable function (PUF) circuit, which is placeable in K different regions on the hardware platform, leading to K different spatial PUF configurations of the PUF circuit;
wherein K is an integer, and K>1; and
wherein the electronic device is configured to
determine a challenge;
determine a currently valid PUF configuration out of the K different PUF configurations; and
determine a local response to the challenge using the PUF circuit according to the valid PUF configuration.

2. The electronic device according to claim 1, wherein the hardware platform comprises a Field Programmable Gate Array (FPGA).

3. The electronic device according to claim 2, wherein
the FPGA comprises different clock regions with different clocks; and
at least some of the K different regions for the K different PUF configurations lie within different clock regions of the FPGA.

4. The electronic device according to claim 2, wherein
the FPGA comprises at least one clock region; and
at least some of the K different regions for the K different PUF configurations lie within different subregions of the clock region of the FPGA.

5. The electronic device according to claim 2, wherein
the FPGA comprises different clock regions; and wherein
at least one of the K different regions for the K different PUF configurations lies on a border between two different clock regions of the FPGA; and/or
at least one of the K different regions for the K different PUF configurations lies within two different clock regions.

6. The electronic device according to claim 2, wherein
the FPGA comprises L different clock regions, with L being an integer, and L>1; and wherein
K=L; or
K>L.

7. The electronic device according to claim 1, wherein
the PUF circuit occupies only a fraction of the hardware platform for each of the K different PUF configurations;
the electronic device comprises one of more functional modules for providing a function of the electronic device, wherein the one or more functional modules are implemented on the hardware platform; and
the electronic device is configured to alter a position of at least one functional module on the hardware platform responsive to a change of the PUF configuration of the PUF circuit.

8. The electronic device according to claim 7, wherein the electronic device is configured to swap the position of a functional module with the position of the PUF circuit responsive to a change of the PUF configuration of the PUF circuit.

9. The electronic device according to claim 1, wherein
the K different PUF configurations form a sequence of PUF configurations which are indexable using index numbers 1 to K; and
the electronic device is configured to change the currently valid PUF configuration sequentially according to the sequence of PUF configurations and/or according to the index numbers 1 to K.

10. The electronic device according to claim 1, wherein
the PUF circuit comprises a ring oscillator PUF; and/or
the PUF circuit comprises a plurality of ring oscillators.

11. The electronic device according to claim 10, wherein a ring oscillator of the PUF circuit comprises a sequence of NAND gates with interjacent AND gates and/or flip flop circuits.

12. The electronic device according to claim 1, wherein
the electronic device comprises a storage unit configured to store configuration data for at least one or for all of the K different PUF configurations; or
the electronic device is configured to receive configuration data; and wherein
the configuration data is indicative of at least one of the K different regions on the hardware platform for implementing a corresponding one of the K different PUF configurations; and wherein
the electronic device is configured to selectively implement the PUF circuit according to a selected one of the K different PUF configurations using the configuration data.

13. The electronic device according to claim 1, wherein
the electronic device is configured to alter the PUF configuration online during operation of the electronic device using dynamic partial reconfiguration; and/or
the electronic device is configured to alter the PUF configuration offline and/or from a remote location.

14. The electronic device according to claim 1, wherein the electronic device is configured to
receive the challenge from a remote device; and
send the local response to the remote device, in order to enable the remote device to authenticate the electronic device.

15. The electronic device according to claim 1, wherein the electronic device is configured to
encrypt a message using the local response, thereby generating an encrypted message; and
send the encrypted message to the remote device.

16. The electronic device according to claim 1, wherein the electronic device is configured to
receive a remote response for the challenge from a remote device;
compare the remote response to the local response; and
authenticate the remote device in dependence of the comparison.

17. The electronic device according to claim 1, wherein the electronic device is configured to identify a new valid PUF configuration based on the local response.

18. The electronic device according to claim 17, wherein
the electronic device is configured to identify the new valid PUF configuration using a random number generator;
the random number generator is configured to provide an integer index number between 1 and K in dependence of the local response; and
the index number is indicative of the PUF configuration out of the K PUF configurations, which is to be used as the new valid PUF configuration.

19. The electronic device according to claim 1, wherein, within an enrolment phase, the electronic device is configured to
receive a set of different challenges from the remote device;
generate a corresponding set of different local responses for the set of different challenges using the PUF circuit according to the valid PUF configuration; and
provide the set of different local responses to the remote device.

20. The electronic device according to claim 19, wherein, within the enrolment phase, the electronic device is configured to
generate K different sets of different local responses for the set of different challenges using the PUF circuit according to the K different PUF configurations, respectively; and
provide the K different sets of different local responses to the remote device.

21. The electronic device according to claim 1, wherein the K different regions of the hardware platform and/or the PUF circuit are such that the PUF circuit exhibits K different sets of challenge-response pairs (CRPs) for the K different PUF configurations.

22. The electronic device according to claim 21, wherein the PUF circuit is such that a set of CRPs comprises 100 or more, or 1000 or more, or 10000 or more CRPs.

23. The electronic device according to claim 1, wherein the electronic device is configured to adapt
a type of the PUF circuit which is placed in the K different regions on the hardware platform; and/or
an operational parameter which is used for operating the PUF circuit, such that for each type of PUF circuit and/or for each setting of the operational parameter, the PUF circuit provides a different set of challenge-response pairs (CRPs).

24. The electronic device according to claim 1, wherein the electronic device is configured to
change the valid PUF configuration subsequent to processing a pre-determined number of challenges; and/or
change the valid PUF configuration once a pre-determined number of challenge-response pairs from the currently valid PUF configuration have been used.

25. A remote device configured to communicate with an electronic device; wherein the remote device is configured to
store K different sets of challenge-response pairs (CRPs) for a PUF circuit of the electronic device, wherein the PUF circuit exhibits K different spatial PUF configurations;
determine a challenge;
determine a currently valid PUF configuration out of the K different PUF configurations; and
determine a remote response to the challenge using the stored set of CRPs for the valid PUF configuration.

26. The remote device according to claim 25, wherein the remote device is configured to
send the challenge to the electronic device;
receive a local response to the challenge from the electronic device;
compare the local response to the remote response; and
authenticate the electronic device based on the comparison.

27. The remote device according to claim 25, wherein the remote device is configured to
receive, from the electronic device, an encrypted message which has been encrypted using a local response to the challenge; and
decrypt the encrypted message using the remote response.

28. The remote device according to claim 25, wherein the remote device is configured to
receive the challenge from the electronic device; and
send the remote response to the electronic device, in order to enable the electronic device to authenticate the remote device.

29. The remote device according to claim 25, wherein the remote device is configured to identify a new valid PUF configuration based on the remote response.

30. The remote device according to claim 29, wherein
the remote device is configured to identify the new valid PUF configuration using a random number generator;
the random number generator is configured to provide an integer index number between 1 and K in dependence of the remote response; and
the index number is indicative of the PUF configuration out of the K PUF configurations, which is to be used as the new valid PUF configuration.

31. The remote device according to claim 25, wherein, within an enrolment phase, the remote device is configured to
send a set of different challenges to the electronic device;
receive a corresponding set of different local responses for the set of different challenges which have been generated using the PUF circuit according to the valid PUF configuration; and
store the set of different local responses in conjunction with the set of different challenges as the set of CRPs for the valid PUF configuration.

32. The remote device according to claim 31, wherein, within the enrolment phase, the remote device is configured to
receive K different sets of different local responses for the set of different challenges, which have been generated using the PUF circuit according to the K different PUF configurations, respectively; and
store each of the K different sets of different local responses in conjunction with the set of different challenges to provide the K different sets of CRPs for the K different PUF configurations, respectively.

33. A method for enabling and/or performing a security related process involving an electronic device; wherein the electronic device comprises a hardware platform and a physical unclonable function (PUF) circuit, which is placeable in K different regions on the hardware platform, leading to K different spatial PUF configurations; wherein K is an integer, and K>1; the method comprising:
determining a challenge;
determining a currently valid PUF configuration out of the K different PUF configurations; and
determining a local response to the challenge using the PUF circuit according to the valid PUF configuration.

34. A method for enabling and/or performing a security related process involving a remote device; the method comprising:
providing, at the remote device, K different sets of challenge- response pairs, referred to as CRPs, for a PUF circuit of an electronic device, wherein the PUF circuit exhibits K different spatial PUF configurations;
determining a challenge;
determining a currently valid PUF configuration out of the K different PUF configurations; and
determining a remote response to the challenge using the stored set of CRPs for the valid PUF configuration.
